(19) United States
(12) Patent Application Publication
(10) Pub. No.: US 2014/0065307 A1
(43) Pub. Date: Mar. 6, 2014

(54) COOLING SUBSTRATE AND ATOMIC LAYER DEPOSITION APPARATUS USING PURGE GAS

(71) Applicant: Synos Technology, Inc., Fremont, CA (US)

(72) Inventor: Sang In Lee, Sunnyvale, CA (US)

(73) Assignee: Synos Technology, Inc., Fremont, CA (US)

(21) Appl. No.: 13/966,103

(22) Filed: Aug. 13, 2013

Related U.S. Application Data
(60) Provisional application No. 61/697,701, filed on Sep. 6, 2012.

(51) Int. Cl. B05C 3/00; B05D 1/40

(52) U.S. Cl. CPC B05C 3/005; B05D 1/40
USPC 427/255.26; 118/724

(57) ABSTRACT

Cooling a heated substrate undergoing a deposition process (e.g., ALD, MLD or CVD) and a deposition reactor for performing the deposition process by routing a cooled purge gas through a path in the deposition reactor and then injecting the cooled purge gas onto the substrate. The deposition reactor may include a heater to heat precursor. As the precursor passes the heater, the precursor is heated to a temperature conducive to the deposition process. As a result of operating the heater and routing the heated precursor, the temperature of the substrate and the deposition reactor may be increased. To drop the temperature of the substrate and the deposition reactor, a purge gas cooled to a temperature lower than the heated precursor is injected onto the substrate via the deposition reactor

### CROSS-REFERENCE TO RELATED APPLICATION

This application claims priority under 35 U.S.C. §119(e) to co-pending U.S. Provisional Patent Application No. 61/697,701 filed on Sep. 6, 2012, which is incorporated by reference herein in its entirety.

### BACKGROUND

1. Field of Art

The disclosure relates to depositing one or more layers of materials on a substrate by using atomic layer deposition (ALD) or other deposition methods, and more particularly to cooling the substrate or a device for performing the atomic layer deposition using a cooled purge gas.

2. Description of the Related Art

Various chemical processes are used to deposit one or more layers of material on a substrate. Such chemical processes include, among others, chemical vapor deposition (CVD), atomic layer deposition (ALD) and molecular layer deposition (MLD). CVD is the most common method for depositing a layer of material on a substrate. In CVD, reactive gas precursors are mixed and then delivered to a reaction chamber where a layer of material is deposited after the mixed gas comes into contact with the substrate.

ALD is another way of depositing material on a substrate. ALD uses the bonding force of a chemisorbed molecule that is different from the bonding force of a physisorbed molecule. In ALD, source precursor is absorbed into the surface of a substrate and then purged with an inert gas. As a result, physisorbed molecules of the source precursor (bonded by the Van der Waals force) are desorbed from the substrate. However, chemisorbed molecules of the source precursor are covalently bonded, and hence, these molecules are strongly adsorbed in the substrate and not desorbed from the substrate. The chemisorbed molecules of the source precursor (adsorbed on the substrate) react with and/or are replaced by molecules of reactant precursor. Then, the excessive precursor or physisorbed molecules are removed by injecting the purge gas and/or pumping the chamber, obtaining a final atomic layer.

MLD is a thin film deposition method similar to ALD but in MLD, molecules are deposited onto the substrate as a unit to form polymeric films on a substrate. In MLD, a molecular fragment is deposited during each reaction cycle. The precursors for MLD have typically been homobifunctional reactants. MLD method is used generally for growing organic polymers such as polyamides on the substrate. The precursors for MLD and ALD may also be used to grow hybrid organic-inorganic polymers such as Alucone (i.e., aluminum alkoxide polymer having carbon-containing backbones obtained by reacting trimethylaluminum (TMA: Al(CH₃)₃) and ethylene glycol) or Zircone (hybrid organic-inorganic systems based on the reaction between zirconium precursor (such as zirconium t-butoxide Zr[OC(CH₃)₃)]₄, or tetrakis(dimethylamido)zieconium Zr[N(CH₃)₂]₄) with diol (such as ethylene glycol)).

During these deposition methods, the substrate may be heated to a high temperature to facilitate and enhance the deposition process. In a lower temperature, the reactiveness of precursor may be inadequate, and hence, the material deposited on the surface of the substrate as a result of exposing the surface to the precursor possesses inferior properties. However, heating the substrate to a high temperature requires a large amount of energy, and slows down the overall depositing process.

### SUMMARY

Embodiments relate to depositing a layer of material on a substrate by heating first precursor using a heater in a deposition reactor to increase reactivity of the first precursor before injecting the first precursor onto the substrate, and injecting cooled purge gas to decrease the temperature of the substrate. The heated precursor is routed into a first chamber formed in a body of the deposition reactor. From the first chamber, the heated first precursor is injected onto a portion of the substrate. The purge gas is routed into a second chamber formed in the body of the deposition reactor. The purge gas is cooled so that the temperature of the routed purge gas is lower than a temperature of the deposition reactor. The purge gas is injected onto the portion of the substrate from the second chamber.

In one embodiment, the temperature of the routed purge gas is lower than the temperature of the portion of the substrate.

In one embodiment, the first precursor remaining after injecting onto the portion of the substrate is routed through a constriction zone of the deposition reactor having a height smaller than a width of the second chamber.

In one embodiment, the first precursor routed through the constriction zone is discharged from the deposition reactor.

In one embodiment, the first precursor is heated by routing the first precursor into a heating chamber in the deposition reactor via a channel formed in the deposition reactor. The heater may be placed in the heating chamber in the path of the first precursor.

In one embodiment, the body of the deposition reactor is insulated from heat generated by the heater using an insulator.

In one embodiment, a relative movement between the deposition reactor and the substrate is caused to inject the routed first precursor and the routed purge gas onto another portion of the substrate.

In one embodiment, the first precursor is heated by routing the first precursor between the heater and a passage wall spaced away from the heater.

In one embodiment, second precursor is heated using another heater in the deposition reactor. The heated second precursor is routed into a third chamber formed in the body of the deposition reactor. The routed second precursor is injected onto the portion of the substrate from the third chamber. The injected firs precursor, the injected second precursor and the routed purge gas are discharged through the same exhaust portion.

### BRIEF DESCRIPTION OF DRAWINGS

Figure (FIG. 1 is a cross sectional diagram of a linear deposition device, according to one embodiment.

FIG. 2 is a perspective view of a linear deposition device, according to one embodiment.

FIG. 3 is a perspective view of a rotating deposition device, according to one embodiment.

FIG. 4 is a perspective view of reactors in a deposition device, according to one embodiment.

FIG. 5A is a cross sectional diagram illustrating a reactor taken along line A-B of FIG. 4, according to one embodiment.

FIG. 5B is a bottom view of the reactor of FIG. 5A, according to one embodiment.

FIG. 6 is a cross sectional diagram of a reactor for injection two different types of precursors, according to one embodiment.

FIG. 7A is a cross sectional diagram illustrating a reactor, according to one embodiment.

FIG. 7B is a cross sectional diagram illustrating a reactor, according to one embodiment.

FIG. 8 is a flowchart illustrating the process of injecting heated precursor and cooled purge gas to perform a deposition process, according to one embodiment.

### DETAILED DESCRIPTION OF EMBODIMENTS

Embodiments are described herein with reference to the accompanying drawings. Principles disclosed herein may, however, be embodied in many different forms and should not be construed as being limited to the embodiments set forth herein. In the description, details of well-known features and techniques may be omitted to avoid unnecessarily obscuring the features of the embodiments.

In the drawings, like reference numerals in the drawings denote like elements. The shape, size and regions, and the like, of the drawing may be exaggerated for clarity.

Embodiments relate to cooling a heated substrate undergoing a deposition process (e.g., ALD, MLD or CVD) and a deposition reactor for performing the deposition process by routing a cooled purge gas through a path in the deposition reactor and then injecting the cooled purge gas onto the substrate. The deposition reactor may include a heater to heat precursor. As the precursor passes the heater, the precursor is heated to a temperature conducive to the deposition process. As a result of operating the heater and routing the heated precursor, the temperature of the substrate and the deposition reactor may be increased. To drop the temperature of the substrate and the deposition reactor, a purge gas cooled to a temperature lower than the heated precursor is injected onto the substrate via the deposition reactor.

Some materials used as substrate may be vulnerable to deformation at relatively low temperature. For example, materials such as polyethylene terephthalate (PET) and polyethylene naphthalate (PEN) have glass transition temperature (T_{g}) of 78° C. and 120° C., respectively. Hence, it is preferable to perform the deposition process (e.g., ALC, MLD or CVD) on such substrate below such glass transition temperature. However, when the deposition process is performed at a low temperature, adsorption and removal of precursor or materials is not performed effectively. By keeping the reactivity of precursor while the temperature of the substrate below the glass transition temperature, layers of material can be deposited on the substrate that has relatively low glass transition temperature.

### Example Apparatus for Performing Deposition

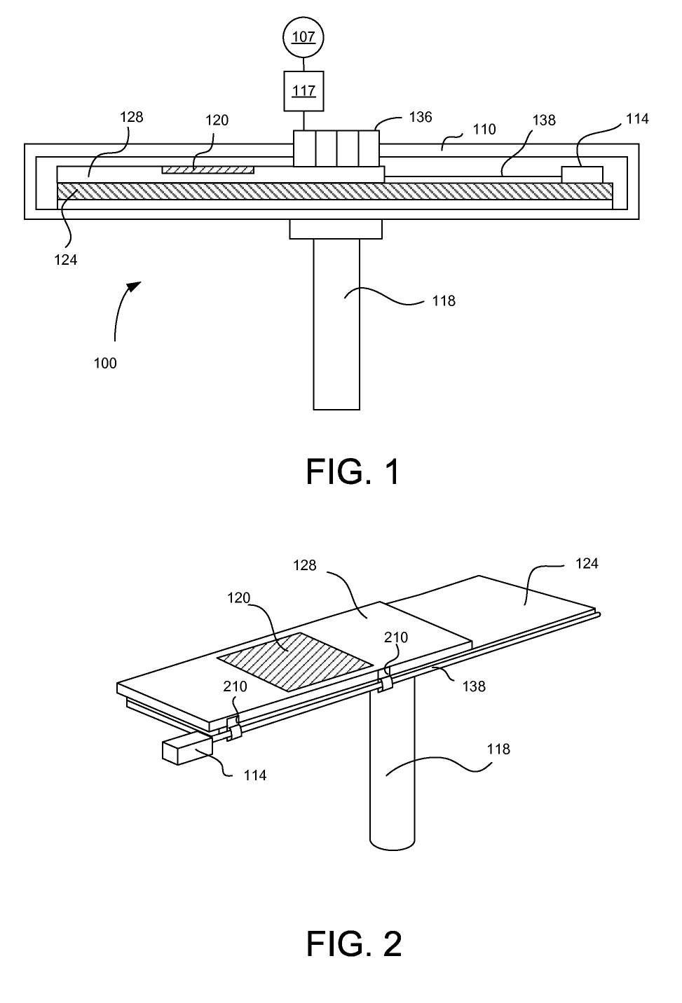

Figure (FIG. 1 is a cross sectional diagram of a linear deposition device 100, according to one embodiment. FIG. 2 is a perspective view of the linear deposition device 100 (without chamber walls to facilitate explanation), according to one embodiment. The linear deposition device 100 may include, among other components, a support pillar 118, the process chamber 110 and one or more reactors 136. The reactors 136 may include one or more of injectors and radical reactors for performing MLD, ALD and/or CVD. Each of the injectors injects source precursors, reactant precursors, purge gases or a combination of these materials onto the substrate 120. The gap between the injector and the substrate 120 may be 0.5 mm to 1.5 mm.

The process chamber enclosed by walls may be maintained in a vacuum state to prevent contaminants from affecting the deposition process. The process chamber 110 contains a susceptor 128 which receives a substrate 120. The susceptor 128 is placed on a support plate 124 for a sliding movement. The support plate 124 may include a temperature controller (e.g., a heater or a cooler) to control the temperature of the substrate 120. Conventionally, the substrate 120 is heated to a temperature of over 250° C., sometimes over 500° C. depending on the precursor being used and the material being deposited on the substrate 120. However, embodiments enable the temperature of the substrate 120 to be maintained at a lower temperature by heating the precursor instead of the substrate 120.

The linear deposition device 100 may also include lift pins (not shown) that facilitate loading of the substrate 120 onto the susceptor 128 or dismounting of the substrate 120 from the susceptor 128.

In one embodiment, the susceptor 128 is secured to brackets 210 that move across an extended bar 138 with screws formed thereon. The brackets 210 have corresponding screws formed in their holes receiving the extended bar 138. The extended bar 138 is secured to a spindle of a motor 114, and hence, the extended bar 138 rotates as the spindle of the motor 114 rotates. The rotation of the extended bar 138 causes the brackets 210 (and therefore the susceptor 128) to make a linear movement on the support plate 124. By controlling the speed and rotation direction of the motor 114, the speed and the direction of the linear movement of the susceptor 128 can be controlled. The use of a motor 114 and the extended bar 138 is merely an example of a mechanism for moving the susceptor 128. Various other ways of moving the susceptor 128 (e.g., use of gears and pinion or a linear motor at the bottom, top or side of the susceptor 128). Moreover, instead of moving the susceptor 128, the susceptor 128 may remain stationary and the reactors 136 may be moved.

One or more reactors 136 of the linear deposition device 100 are connected to a purge gas source 107 via a cooling device 117. The purge gas source may be a canister or any other conventional storage device that stores the purge gas to the reactors 136. The cooling device 117 may by any chiller commercially available . The cooling device 117 cools the temperature of the purge gas to a temperature lower than the temperature of the heated precursor. Preferably, the temperature of the purge gas is cooled to a temperature lower than the temperature of the reactors 136 and the substrate 120. In one embodiment, the temperature of the purge gas is in the range of 5° C. to 30° C.

Gases that may be used as purge gas may include, for example, inert gas such as nitrogen and Argon.

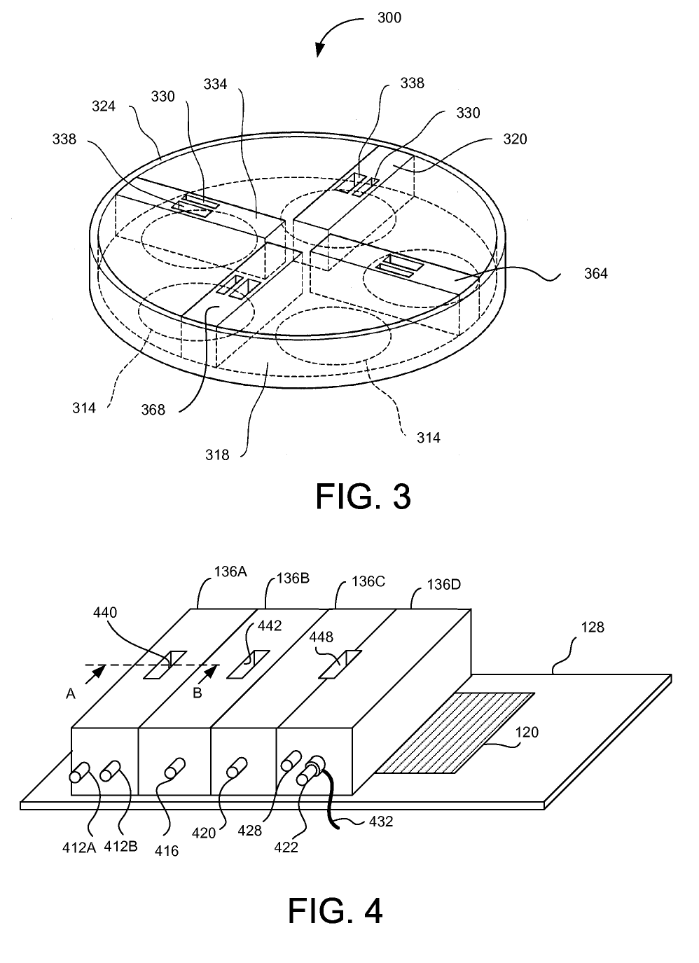

FIG. 3 is a perspective view of a rotating deposition device 300, according to one embodiment. Instead of using the linear deposition device 100 of FIG. 1, the rotating deposition device 300 may be used to perform the deposition process according to another embodiment. The rotating deposition device 300 may include, among other components, reactors 320, 334, 364, 368, a susceptor 318, and a container 324 enclosing these components. A reactor (e.g., 320) of the rotating deposition device 300 corresponds to a reactor 136 of the linear deposition device 100, as described above with reference to FIG. 1. The susceptor 318 secures the substrates 314 in place. The reactors 320, 334, 364, 368 may be placed with a gap of 0.5 mm to 1.5 mm from the substrates 314 and the susceptor 318. Either the susceptor 318 or the reactors 320, 334, 364, 368 rotate to subject the substrates 314 to different processes.

One or more of the reactors 320, 334, 364, 368 are connected to gas pipes (not shown) to provide source precursor, reactant precursor, purge gas and/or other materials. The materials provided by the gas pipes may be (i) injected onto the substrate 314 directly by the reactors 320, 334, 364, 368, (ii) after mixing in a chamber inside the reactors 320, 334, 364, 368, or (iii) after conversion into radicals by plasma generated within the reactors 320, 334, 364, 368. After the materials are injected onto the substrate 314, the redundant materials may be exhausted through outlets 330, 338. The interior of the rotating deposition device 300 may also be maintained in a vacuum state.

The rotating deposition device 300 may also be equipped with one or more heaters to increase the temperature of the substrate 314.

One or more of the reactors 320, 334, 364, 358 are connected to a cooling device to receive cooled purge gas.

Although following embodiments are described primarily with reference to the reactors 136 in the linear deposition device 100, the same principle and operation can be applied to the rotating deposition device 300 or other types of deposition device.

FIG. 4 is a perspective view of reactors 136A through 136D (collectively referred to as the “reactors 136”) in the deposition device 100 of FIG. 1, according to one embodiment. The reactors 136A through 136D are placed in tandem adjacent to each other. In other embodiments, the reactors 136A through 136D may be placed with a distance from each other. As the susceptor 128 mounting the substrate 120 moves from the left to the right or from the right to the left, the substrate 120 is sequentially injected with materials or radicals by the reactors 136A through 136D to form a deposition layer on the substrate 120. The injected material includes, among others, heated precursor and cooled purge gas. Instead of moving the substrate 120, the reactors 136A through 136D may move from the right to the left while injecting the source precursor materials or the radicals on the substrate 120.

In one or more embodiments, the reactors 136A, 136B, 136C are gas injectors that inject precursor material, purge gas or a combination thereof onto the substrate 120. Each of the reactors 136A, 136B, 136C is connected to pipes 412A, 412B, 416, 420 to receive precursors, purge gas or a combination thereof from one or more sources. Valves and other pipes may be installed between the pipes 412, 416, 420 and the sources to control the gas and the amount thereof provided to the gas injectors 136A, 136B, 136C. Excess precursor and purge gas molecules are exhausted via exhaust portions 440, 442, 448.

The reactor 136D may be a radical reactor that generates radicals of gas or a gas mixture received from one or more sources. The radicals of gas or gas mixture may function as purge gas, reactant precursor, surface treating agent, or a combination thereof on the substrate 120. The gas or gas mixtures are injected into the reactor 136D via pipe 428, and are converted into radicals within the reactor 136D by applying voltage across electrodes (e.g., electrode 422 and body of the reactor 136C) and generating plasma within a plasma chamber. The electrode 422 is connected via a line 432 to a supply voltage source and the body of the reactor 136, which forms a coaxial capacitive-type plasma reactor, is grounded or connected to the supply voltage source via a conductive line (not shown). The generated radicals are injected onto the substrate 120, and remaining radicals and/or gas reverted to an inactive state from the radicals are discharged from the reactor 136D via the exhaust portion 448. By exposing the substrate 120 to the radicals, the surface of the substrate maintained reactive until the next precursor is injected onto the surface of the substrate.

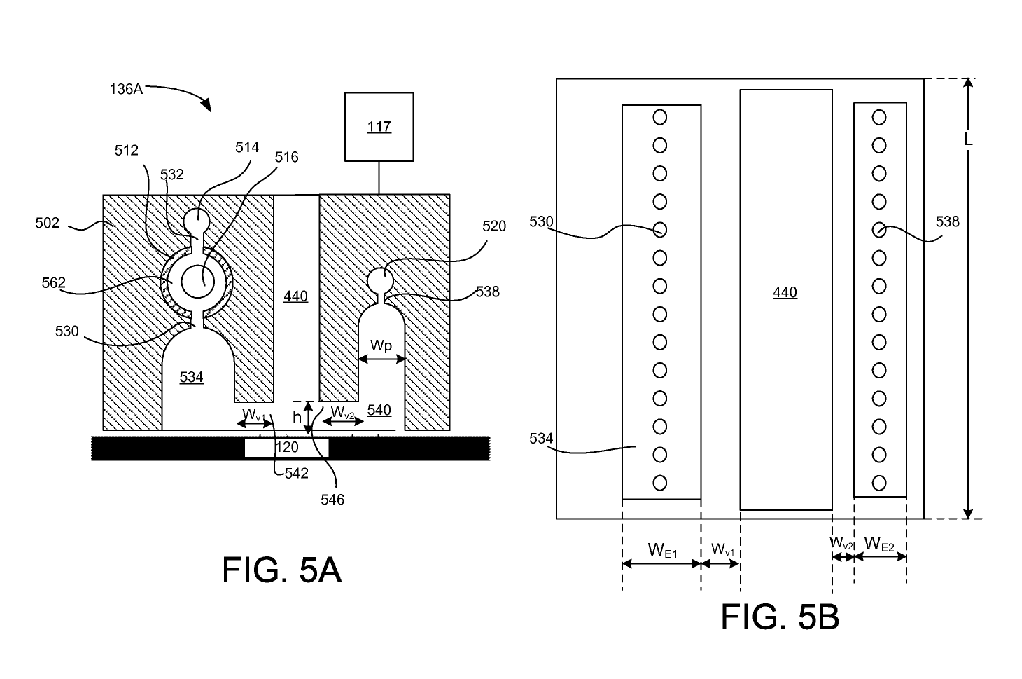

FIG. 5A is a cross sectional diagram illustrating the reactor 136A taken along line A-B of FIG. 4, according to one embodiment. The reactor 136A includes, among other components, a body 502, a heater 516, and an insulator 512. The body 502 is formed with gas channels 514, 520, a heating chamber 562, perforations (slits or holes) 530, 532, 538, chambers 534, 540, constriction zones 542, 546, and an exhaust portion 440. The gas channel 514 is connected to the pipe 412A to convey precursor into the chamber 534 via the perforations 530, the heating chamber 562 and the perforations 530. As the precursor passes through the heating chamber 562, the precursor is heated to a predetermined temperature. The precursor heated in the reactor 136A may be source precursor or reactant precursor.

The heated precursor enters the chamber 534 and comes into contact with the substrate 120 below the chamber 534. The heated precursor remaining after adsorption, replacement of molecules or reaction with molecules on the substrate 120 passes through the constriction zone 542 and is discharged via the exhaust portion 440. As the precursor passes through the constriction zone 542, Venturi effect causes the pressure of the precursor to drop and the speed of the precursor to increase in the constriction zone 542. As a result, removal of excess precursor on a portion of the substrate 120 below the constriction zone 542 is facilitated.

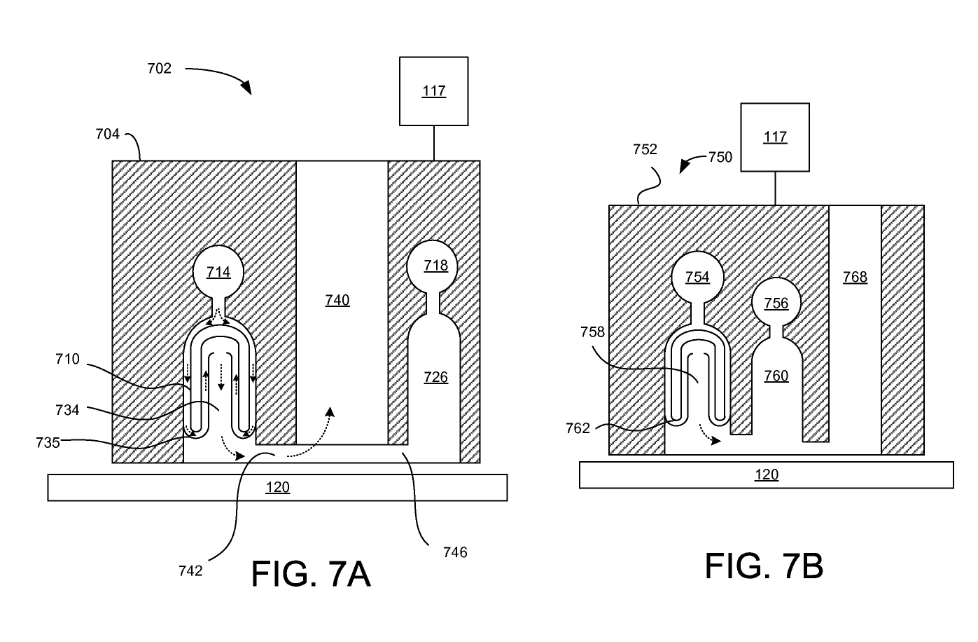

The heater 516 is placed in the heating chamber 562 to heat the precursor as the precursor passes through the heating chamber 562. The precursor may be heated, for example, to a temperature of 50° C. to 350° C. In the embodiment of FIG. 5A, the heater 516 is cylindrically shaped and extends longitudinally across the heating chamber 562. However, the heater 516 may be in various shapes other than the cylindrical shape, and may be placed in different locations, as illustrated below in detail with reference to FIGS. 7A and 7B. The heater 516 may be operated by applying electric current to the heater. The insulator 512 may be placed between the body 502 and the heater 516 to retain the heating chamber 562 at a high temperature and reduce the heat transferred to the body 502. By reducing the amount of heat transferred to the body 502, the rise in temperature of the body 502 can also be inhibited. In one embodiment, the insulator 512 is made of ceramic or quartz. Quartz is preferable over ceramic since (i) quartz is relatively easy to process, (ii) quartz is unlikely to introduce contaminants, and (iii) quartz is unlikely to be deformed at relatively high temperature (e.g., 350° C.).

The gas channel 520 is connected to the pipe 412B to convey purge gas (e.g., Argon) into the chamber 540 via the perforations 538. The purge gas is cooled down to a low temperature by the cooling device 117 placed externally from the reactor 136. In other embodiments, the cooling device 117 may be installed inside the reactor 136A. The purge gas is then discharged to the exhaust portion 440 via the constriction zone 546. As the purge gas passes the constriction zone 546, the Venturi effect causes the pressure to drop and the speed of the purge gas to increase. To cause the Venturi effect in the constriction zone 546, the height h of the constriction zone is smaller than width Wp of the chamber 540. The Venturi effect of the purge gas facilitates further removal of the excess precursor remaining on the surface of the substrate 120.

In one embodiment, the cooled purge gas also cools the body 502 of the reactor 136A. The reactor 136A may be heated due to the heat generated at the heater 516 and the heated precursor. The cooled purge gas removes heat from the reactor 136A, obviating or alleviating the need for a separate cooling mechanism for the reactor 136A. The cooled purge gas may be at a temperature range of 5° C. to 30° C.

FIG. 5B is a bottom view of the reactor 136A of FIG. 5A, according to one embodiment. The reactor 136A has a width of L. The chambers 534, 540 have width of W_{E1} and W_{E2}, respectively. The constriction zones 542, 546 also have width of Wᵥ₁ and Wᵥ₂, respectively.

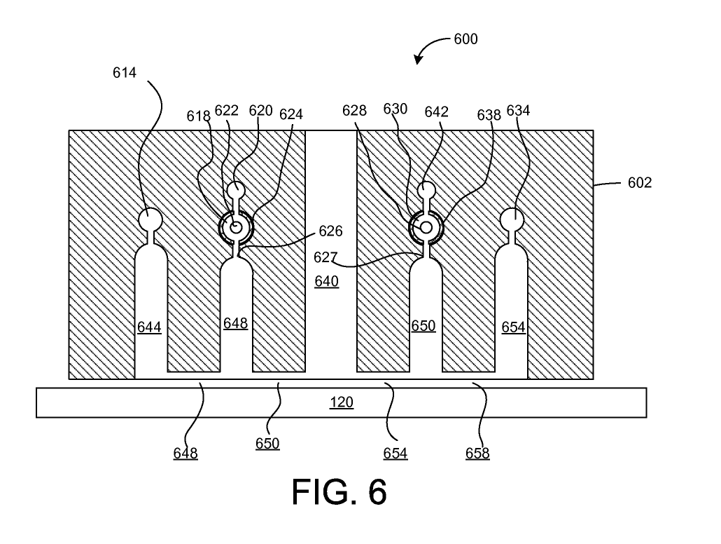

FIG. 6 is a cross sectional diagram of a reactor 600 for injection two different types of precursors, according to one embodiment. The two different types of precursors may be a source precursor and a reactant precursor. As the substrate 120 moves below the reactor 600, the substrate 120 is exposed to different precursors and is deposited with a layer of material on the substrate 120.

The reactor 600 includes a body 602 formed with chambers 648, 650 for exposing the substrate 120 to precursors, chambers 644, 654 for receiving cooled purge gas via channels 614, 634, an exhaust portion 640 for discharging the excess precursors and purge gas from the reactor 600, and constriction zones 648, 650, 654, 658. The reactor also includes heaters 622, 628 for heating the precursor injected into the chambers 648, 650 via channels 620, 642.

The reactor 600 also includes insulator 624, 638 to reduce the amount of heat transmitted to the body 602 from the heaters 622, 638 and heated precursors. In one embodiment, a source precursor is injected into the chamber 648 via channel 620, a heating chamber 618 and perforations 626. A reactant precursor is injected into chamber 650 via a channel 642, a heating chamber 630 and perforations 627.

Purge gas is cooled and injected into chambers 644, 654 via channels 614, 634. The purge gas cools the body 602 and the substrate 120 before being discharged via the exhaust portion 640. In this way, the need for a separate cooling mechanism for the reactor 600 may be obviated or alleviated.

FIG. 7A is a cross sectional diagram illustrating a reactor 702, according to one embodiment. The reactor 702 includes a body 704 formed with channels 714, 718, chambers 734, 726 and an exhaust portion 740. The reactor 702 also includes a heater 710 installed within chamber 734. The heater 710 has a cross-sectional shape that parallels the shape of the interior walls of the chamber 734. Specifically, the heater 710 in the embodiment of FIG. 7A has a non-circular cross-sectional shape of a horseshoe. The heater 710 is surrounded by a passage wall 735 that forces the precursor to flow along the outer surface of the heater 710, as shown by dashed arrows in FIG. 7A. The heater 710 is provided in chamber 734 that is open to the substrate. Precursor is routed via channel 714 to chamber 734 via heater 710.

As the precursor flows through the heater 710, the precursor is heated and discharged into the chamber 734. The heated precursor comes into contact below the chamber 734 and is discharged to the exhaust portion 740 via a constriction zone 742.

Purge gas is cooled by the cooling device 117 before being injected into the chamber 726 via the channel 718. The purge gas passes through the construction zone 746 is discharged through the exhaust portion 740. The purge gas decreases the temperature of the body 704 and the substrate 120.

FIG. 7B is a cross sectional diagram illustrating a reactor 750, according to one embodiment. The reactor 750 is different from reactor 702 in that channel 756 and chamber 760 for injecting the purge gas is placed between an exhaust portion 768 and channel 754 and chamber 758 for injecting the precursor. A heater 762 is placed in the chamber 758 to heat the precursor traveling to the chamber 758 via the channel 754. The purge gas is cooled by the cooling device 117 before entering the channel 756.

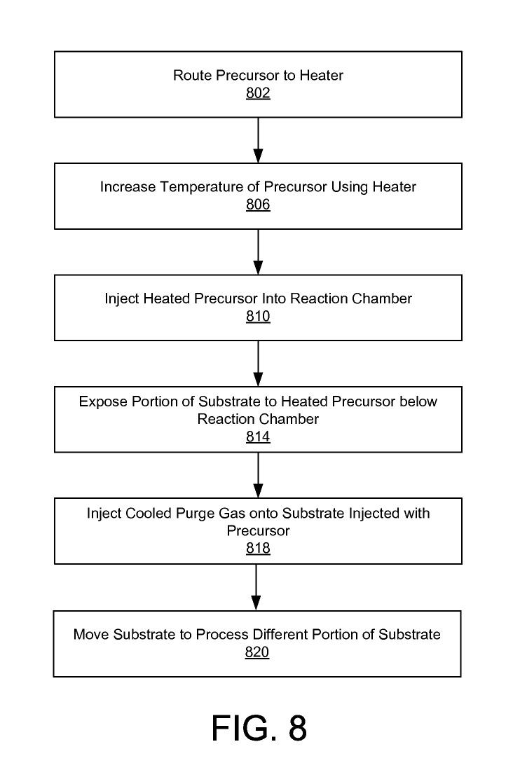

FIG. 8 is a flowchart illustrating the process of injecting heated precursor and cooled purge gas to perform a deposition process, according to one embodiment. Precursor is routed 802 to a heater. As the precursor passes through a heating chamber, the temperature of the precursor is increased 806. The heated precursor is then injected 810 into a reaction chamber. The purge gas decreases the temperature of the body of the deposition reactor and the substrate.

A portion of the substrate below the reaction chamber is exposed 814 to the precursor. If the precursor is source precursor, the precursor molecules are adsorbed in the substrate. If the precursor is reactant precursor, the precursor molecules react or replace the source precursor molecules adsorbed on the substrate. The portion of the substrate may be exposed to purge gas to remove excess precursor molecules or excess materials formed as a result of reaction of the precursor molecules.

Cooled purge gas is injected 818 onto the substrate to the substrate injected with the precursor to remove excess source precursor, reactant precursor, material formed by reaction of the source precursor and the reactant precursor, or a combination thereof from the deposition reactor and/or the substrate. The cooled purge gas also decreases the temperature of the body of the deposition reactor and/or the substrate.

The substrate is then moved 820 to process a different portion of the substrate by repeating routing 802 of the precursor through injecting 818 cooled purge gas.

Upon reading this disclosure, those of ordinary skill in the art will appreciate still additional alternative structural and functional designs through the disclosed principles of the embodiments. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

1. A method of depositing a layer of material on a substrate, comprising:
heating first precursor using a heater in a deposition reactor to increase reactivity of the first precursor;
routing the heated first precursor into a first chamber formed in a body of the deposition reactor;
injecting the routed first precursor from the first chamber onto a portion of the substrate;
routing purge gas into a second chamber formed in the body of the deposition reactor, a temperature of the routed purge gas lower than a temperature of the heated first precursor; and
injecting the routed purge gas onto the portion of the substrate to lower a temperature of the substrate.

2. The method of claim 1, wherein the temperature of routed purge gas is lower than a temperature of the portion of the substrate.

3. The method of claim 1, further comprising routing the first precursor remaining after injecting onto the portion of the substrate through a constriction zone of the deposition reactor having a height smaller than a width of the first chamber.

4. The method of claim 3, further comprising discharging the first precursor routed through the constriction zone from the deposition reactor.

5. The method of claim 1, further comprising routing the injected purge gas onto the portion of the substrate through a constriction zone of the deposition reactor having a height smaller than a width of the second chamber.

6. The method of claim 5, further comprising discharging the purge gas routed through the constriction zone from the deposition reactor.

7. The method of claim 1, wherein heating the first precursor comprises routing the first precursor into a heating chamber in the deposition reactor via a channel formed in the deposition reactor, the heater placed in the heating chamber in a path of the first precursor.

8. The method of claim 7, further comprising insulating the body of the deposition reactor from heat generated by the heater.

9. The method of claim 1, further comprising causing a relative movement between the deposition reactor and the substrate to inject the routed first precursor and the routed purge gas onto another portion of the substrate.

10. The method of claim 1, wherein heating the first precursor comprises routing the first precursor between the heater and a passage wall spaced away from the heater.

11. The method of claim 1, further comprising:
heating second precursor using another heater in the deposition reactor;
routing the heated second precursor into a third chamber formed in the body of the deposition reactor;
injecting the routed second precursor from the third chamber onto the portion of the substrate; and
discharging the injected first precursor, the injected second precursor and the routed purge gas through a same exhaust portion.

12. The method of claim 1, wherein the injected purge gas further removes the first precursor physisorbed on the substrate.

13. A deposition reactor for depositing a layer of material on a substrate, comprising:
a body formed with:
a first channel configured to route precursor,
a second channel configured to route purge gas,
a first chamber configured to receive heated precursor and inject the heated precursor onto a portion of the substrate, and
a second chamber configured to receive the purge gas and inject the purge gas onto the portion of the substrate to lower a temperature of the substrate;
a heater placed in the body to generate the heated precursor with increased reactivity by heating the precursor routed via the first channel, the temperature of the heated precursor higher than a temperature of the purge gas; and
a mechanism configured to cause relative movement between the body and the substrate.

14. The deposition reactor of claim 13, wherein the temperature of routed purge is lower than a temperature of the portion of the substrate.

15. The deposition reactor of claim 13, wherein the body is further formed with:
a first constriction zone connecting the first chamber to an exhaust portion for discharging the heated precursor after exposing the portion of the substrate to the heated precursor; and
a second constriction zone connecting the second chamber to the exhaust portion to discharge the purge gas after exposing the portion of the substrate to the purge gas.

16. The deposition reactor of claim 15, wherein a height of the second constriction zone is smaller than a width of the second chamber.

17. The deposition reactor of claim 13, wherein the body is formed with a heating chamber in which the heater is placed, the heating chamber connected to the first channel and the first chamber.

18. The deposition reactor of claim 17, further comprising an insulator at least surrounding the heating chamber to insulate the body of the deposition reactor from heat of the heater and the heated precursor.

19. The deposition reactor of claim 13, wherein the mechanism is configured to cause the relative movement between the deposition reactor and the substrate to inject the heated precursor and the purge gas onto another portion of the substrate.

20. The deposition reactor of claim 13, further comprising a passage wall spaced away from the heater to route the precursor to the first chamber.
